(19) United States
(12) Patent Application Publication
(10) Pub. No.: US 2015/0133168 A1
(43) Pub. Date: May 14, 2015

(54) System and Method for Communicating Information Based on a User's Location

(71) Applicant: Roy Jay, Orlando, FL (US)

(72) Inventor: Roy Jay, Orlando, FL (US)

(21) Appl. No.: 14/539,301

(22) Filed: Nov. 12, 2014

Related U.S. Application Data
(60) Provisional application No. 61/902,565, filed on Nov. 11, 2013.

(51) Int. Cl. H04W 4/02

(52) U.S. Cl. CPC H04W 4/02
USPC 455/456.3

(57) ABSTRACT

A system for providing information to a user based on the user's location is provided. More particularly, a system is provided comprising a communication device, at least one location identifying device capable of transmitting location identification information to the communication device when the communication device is within a certain range of the location identifying device and a control system capable of transmitting location-based information to the communication device based on the location identification information sent by the communication device to the control system.

### CROSS REFERENCE TO RELATED APPLICATIONS

The present application claims priority to co-pending Provisional Patent Application No. 61/902,565, filed on Nov. 11, 2013, entitled “System and Method for Communicating Information Based on a User's Location”; that application being incorporated herein, by reference, in its entirety.

### BACKGROUND OF THE INVENTION

1. Field of the Invention

The present invention relates to a system and method of providing information and, more particularly, to a system and method for providing information to a user based on the user's location.

2. Description of the Related Art

In today's environment of technically advanced smartphones, tablets and other portable communication devices, people have come to expect and rely upon having information immediately available at all times. Users of these devices are able to access the internet at all times from almost anywhere and, once they are online, they can search for any desired, available information.

In addition to the ability to access information online, many smartphones, tablets and other portable communication devices include global positioning satellite (“GPS”) and other navigation functionality that allows for the general location of the device to be determined. This enables users to access information based on and relevant to their location. Typically, the user will manually access a website or application downloaded onto the electronic device and the desired information will be provided to the user's device based on the user's location. This process requires the user's active participation to access the website or application and request the desired location-based information.

Although this perpetual access to online information is available, there is a continuous desire to provide and receive information quicker, easier and precisely at the time it is needed. This is especially the case for people seeking to market and sell products and services. Clearly, the objective for these people is to reach their target consumer precisely at the moment that the consumer is in need of or otherwise desires the particular product or service.

In certain service instances, such as real estate sales and rentals and museum and other property tours, information may be beneficial to a person when that person is in a particular location. For example, in lieu of personal tours, museums and other properties often provide the visitor with a handheld audio device that will play prerecorded audio when the user selects his or her location. However, these devices do not automatically identify the visitor's location and play the audio based on that location. Instead, the visitor inputs his or her location into the device and the device then plays the prerecorded audio based on the manually inputted location. These prior art devices require the active participation of the user in order to access and play the prerecorded audio and oftentimes result in audio intended for a different location being played due to the user inputting the wrong location identifier into the device. In many of these instances, the visitor will simply listen to the wrong audio information being played without realizing that the wrong information is being played.

With respect real estate sales and rentals, location specific information may be critical to properly market and sell or lease the property. It may be important in those instances to provide complete and consistent information about the property to the prospective buyer/lessee to best market the property. However, properties are typically shown by real estate agents and property owners or managers and the information conveyed to the prospective buyer/lessee is simply what that person remembers to say at the moment, which oftentimes results in important information about the property not being disclosed at all or not being disclosed when the prospective buyer/lessee is in the location of the property to which the information relates.

Additionally, the traditional process of real estate agents and property owners or managers conveying information in person to prospective buyers/lessees means that the real estate agent and property owner or manager must be physically present at the property when the property is shown to the prospective buyer/lessee. This manual process limits the volume of properties that can be shown during a day because the real estate agent and property owner or manager can only be in one place at a time.

Accordingly, there is a need in the art for a new and improved system and method for providing information to a user based on the user's location. Any such system should be capable of identifying the user's location and communicating the information to the user through the user's smartphone, tablet or other portable electronic device having location-based functionality. Such system should be further capable of being automated so that the information is provided automatically when the user is within a certain geographic area. Such system should also provide the user with the ability to define whether the information will be provided automatically when the user is within a certain geographic area or whether the information will only be provided as requested by the user. Any such system should additionally enable people to simultaneously provide different information to different people in different locations, thereby enabling real estate agents, for example, to show multiple properties to prospective buyers/lessees at the same time to increase the real estate agent's business and revenue potential. The present invention is particularly suited to overcome those problems which remain in the art in a manner not previously known or contemplated.

### SUMMARY OF THE INVENTION

The present invention is directed towards a system for providing information to a user based on the user's location. In one particular embodiment of the invention, the system comprises a communication device such as a smartphone, at least one location identifying device capable of transmitting location identification information to the communication device when the communication device is within a certain range of the location identifying device and a control system capable of transmitting location-based information to the communication device based on the location identification information sent by the communication device to the control system.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a block diagram of a preferred embodiment of the system of the present invention.

FIG. 2 is a top plan view of a floor plan showing positioning of the location identifying devices.

FIG. 3 is screenshot of the software application.

FIG. 4 is screenshot of the software application.

FIG. 5 is screenshot of the software application.

FIG. 6 is screenshot of the software application.

### DETAILED DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

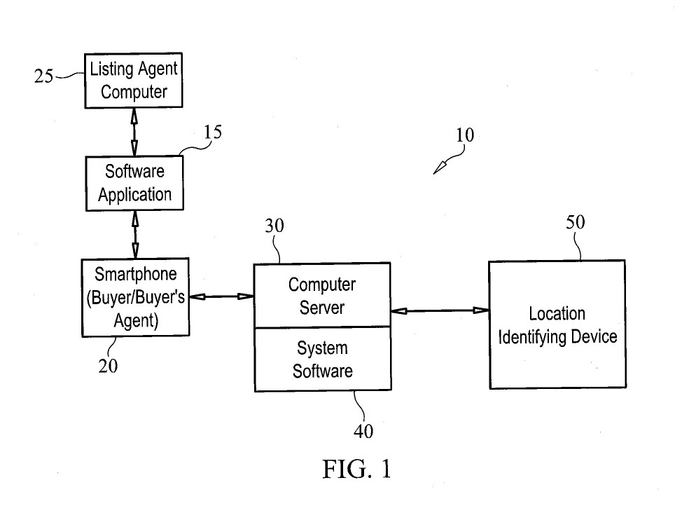

Referring now to FIGS. 1-6, the present invention is directed towards a new and improved system and method for providing information to a user based on the user's location. Although the system and method of the present invention may be used for different applications and purposes, the description below will describe usage of the system by real estate brokers and agents in connection with showings of properties to prospective buyers and their real estate agents. However, it should be appreciated that the system of the present invention may be utilized in connection with other applications within the spirit and scope of the invention.

In a first preferred embodiment, the system 10 comprises application software 15, a communication device 20 used by the person receiving the location-based information, a computer 25 used by the person providing the location-based information, a computer server 30, system operating software 40 and one or more location identifying devices 50. For the real estate application, the person receiving the location-based information will typically be the prospective buyer or the prospective buyer's real estate agent and the person providing the location-based information will typically be the listing real estate agent.

The application software 15 is downloaded into the communication device 20 by the person receiving the location-based information and into the computer 25 by the person providing the location-based information. The application software 15 can be remotely downloaded from the server 30 or from a device service provider, such as Apple or Blackberry, or any other source capable of communicating with the communication device 20 and computer 25. Different versions of the application software 15 may be downloaded and used by the person receiving the location-based information and by the person providing the location-based information. The application software 15 for the communication device 20 is structured to provide the interface and functionality necessary for the communication device 20 to transmit its location information to the computer server 30 and to receive the information associated with that location. The application software 15 for the computer 25 is structured to provide the interface and functionality necessary for the person providing the location-based information to input the desired information into the computer 20 and the computer 20 to transmit such information to the computer server 30.

The communication device 20 can be (i) a smartphone, such as an iPhone, Blackberry, Galaxy or other Android-based smartphone, windows-based smartphone or any other smartphone platform now known or later developed, (ii) a tablet, such as an iPad, Blackberry-based tablet, Galaxy or other Android-based tablet, windows-based tablet or any other tablet platform now known or later developed, or (iii) any other communication device now known or later developed that is capable of determining and transmitting a user's location to the computer server 30 and receiving and displaying or audibly playing information. For purposes of the below description, a smartphone will be referenced as the communication device 20. However, it should be appreciated that any other communication device described above can be utilized within the spirit and scope of the invention.

Similarly, the computer 25 can be (i) a desktop or laptop computer, (ii) a tablet, such as an iPad, Blackberry-based tablet, Galaxy or other Android-based tablet, windows-based tablet or any other tablet platform now known or later developed, (iii) a smartphone, such as an iPhone, Blackberry, Galaxy or other Android-based smartphone, windows-based smartphone or any other smartphone platform now known or later developed or (iv) any other communication device now known or later developed that is capable of inputting the desired information, transmitting such information to the computer server 30 and receiving communications and other information from the computer server 30.

The system operating software 40 is installed on the computer server 30 and includes all functionality necessary to drive the system 10, including, without limitation, (i) communications with the computer 25 to receive the location-based information input into the computer 25 and to transmit communications and other information to the computer 25, (ii) storage of the location-based information received from the computer 25, (iii) communications with the smartphone 20 to receive the smartphone's location, to transmit data and information to the smartphone 20 applicable to such location and to receive communications and other information from the smartphone 20, and (iv) algorithms and processing capabilities to determine the stored information to be transmitted to the smartphone 20 based on the location information received from the smartphone 20 and to control and perform the other functions of the present invention described herein.

The location identifying devices 50 are structured to define the precise location of the smartphone. In one preferred embodiment, devices using Apple's iBeacon technology are used as the location identifying devices 50. The iBeacon-enabled devices communicate using Bluetooth Low Energy. In contrast to Global Positioning Satellite (GPS) technology, which can only define a device's location within a fairly wide range and which may not function within buildings, tunnels, cloud cover and other locations that do not have a clear line of sight to the sky where the satellites are located, Bluetooth Low Energy can define locations within very short distances without the same line of site issues associated with GPS. Although the following description of one preferred embodiment describes usage of iBeacon-enabled devices as the location identifying devices 50, it should be appreciated that other location identifying devices 50 now known or later developed may be utilized with the system 10 of the present invention within the spirit and scope of the invention.

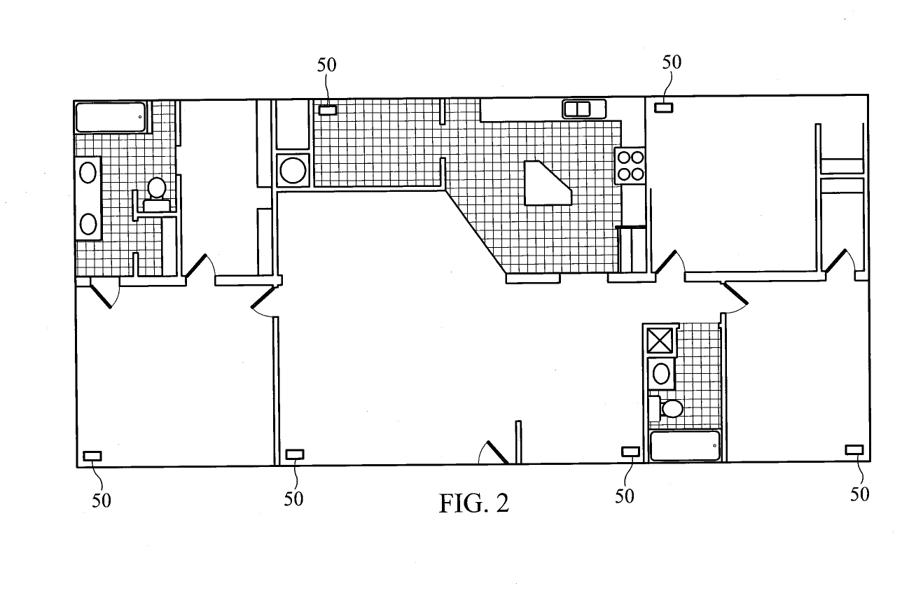

Referring now to FIG. 2, the location identifying devices 50 are positioned within different rooms or areas of the house or building being shown. Each location identifying device 50 has a unique identifier that allows the real estate listing agent to correlate the information inputted into the computer 25 to the specific location identifying device 50 so that the information can be stored in the computer server 30 with its designated location information and the system operating software 40 can then extract the information specific to a location when it receives information that the smartphone 20 is within the desired range of the location identifying device 50 in that location and transmit such location-based information to the prospective buyer's and/or real estate agent's smartphone while they are still in that location. In the event the ranges of two or more location identifying devices 50 overlap, resulting in the smartphone 20 communicating with more than one location identifying device 50 at the same time, the system software 40 includes algorithms to determine which location identifying device 50 is controlling in that instance so that location-based information for only one location is transmitted to the smartphone 20. In making that determination, the algorithms may consider the relevant distances between the smartphone 20 and each of the location identifying devices 50, the direction of movement of the smartphone 20 from the prior location determination, and other factors to determine the appropriate location-based information to transmit to the smartphone 20.

Once the location identifying devices 50 are positioned, the real estate listing agent accesses the application software 15 on the computer 25 and inputs the information relevant to the location of each location identifying device 50. The information may be in the form of text, photos, video and/or audio. The content of the information will be determined by the listing agent. The application software 15 will prompt the person entering the data to define the unique identifier for each location identifying device 50 so that the information is stored within the system software 40 by location. Alternatively, the listing agent can provide the location-based information to the system 10 operator to be inputted into the system 10.

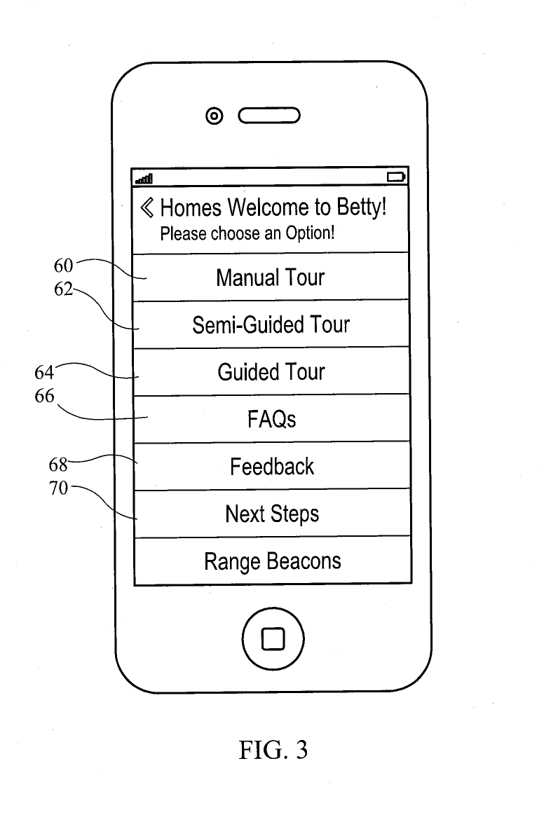

The prospective buyer or real estate agent that has downloaded the application software 15 into a smartphone 20 will have several options to determine how the information will be transmitted by the computer server 30 to their smartphone 20. FIG. 3 illustrates an example menu screen displayed on the smartphone 20. In this example, the user may select a manual tour 60 to receive the location-based information on the smartphone 20 only when requested by the user, to have a guided tour 64 to automatically receive the information on the smartphone 20 when in the vicinity of the applicable location identifying device 50 or a semi-guided tour 62 to receive a prompt on the smartphone 20 when in the vicinity of the applicable location identifying device 50 asking whether the user wants the computer server 30 to transmit the information for that particular location. The screen may also allow the user to access frequently asked questions about the property 66, to provide feedback 68 to the listing agent about the property and to communicate with the listing agent about the next steps in the buying process 70.

In the manual tour 60 mode, the user may request and receive the location-based information on the smartphone 20 at any time and from any location since the user in that mode will be manually selecting the property and the location within the property about which he or she would like the computer server 30 to transmit the information to the smartphone 20, in contrast to the guided tour 64 and semi guided tour 62 modes which rely on the location identifying devices 50 to determine their location and the appropriate information to transmit to the smartphone 20. In this manner, the prospective buyer and his or her real estate agent can remotely view and learn about the property before actually visiting the property and remotely revisit the property after their visit. This on-demand feature will enhance the property showing process and enable the prospective buyer to readily view multiple properties, each time with the same complete information as they would receive when visiting the property, to facilitate their ability to compare and contrast alternative properties and select the property to purchase. Without this feature, prospective buyers may require multiple visits to the property, which will be limited by the availability of the listing real estate agent and/or the prospective buyer's real estate agent. In some instances, the unavailability of one or both of these real estate agents may result in the prospective buyer electing to purchase a different property, which is detrimental to the property seller.

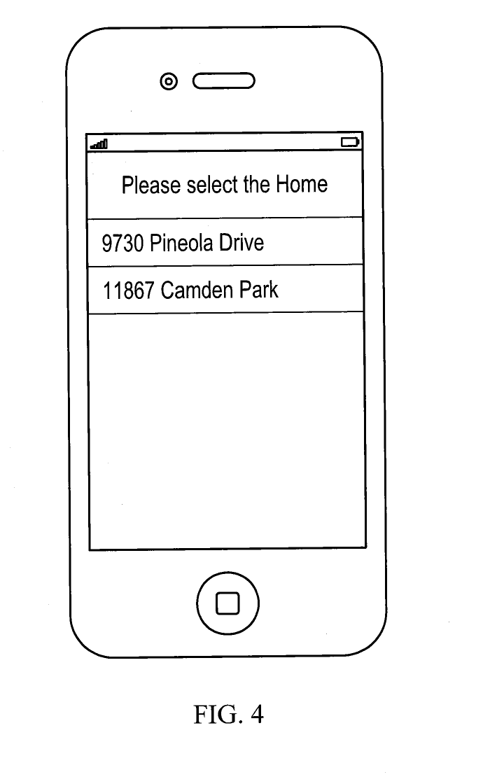

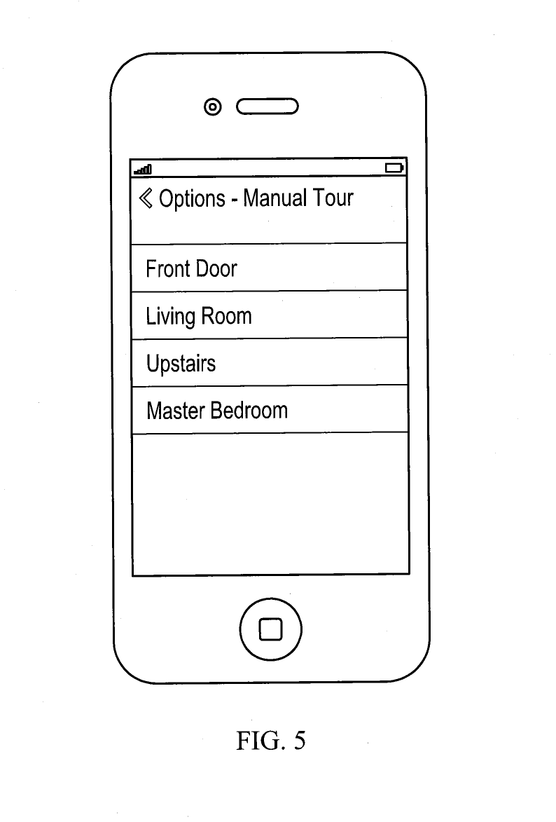

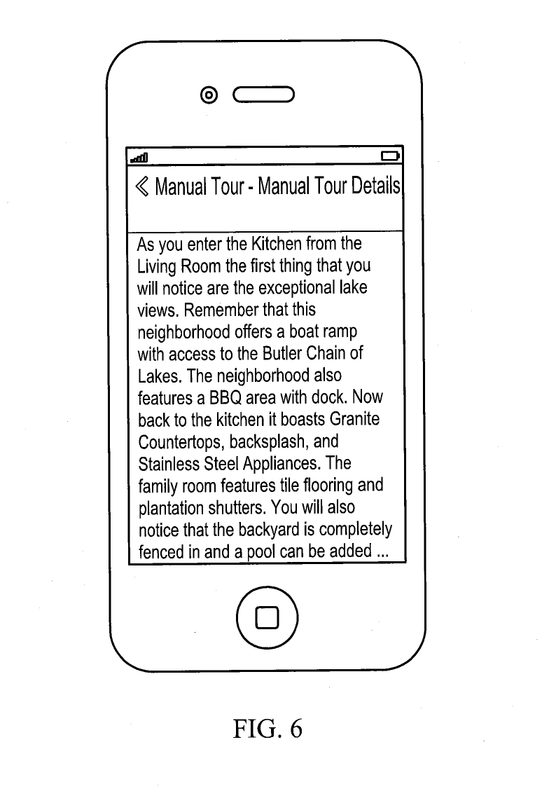

Referring now to FIGS. 4-5, if the manual tour 60 is selected, the user will then select the property for which the tour will be provided. Once the property is selected, the user may select the particular locations that they would like to receive information. As the user selects the particular location (i.e., living room or master bedroom), the smartphone communicates that request to the system software 40 and the system software 40 extracts that location-based information from the computer server 30 and transmits the requested information to the smartphone 20. FIG. 6 illustrates specific location-based information in text form that may be sent to the smartphone 20. As stated above, the information may be provided in text, photo, video or audio form.

If the user selects the semi-guided tour 62 or guided tour 64, when the prospective buyer or his or her real estate agent with a smartphone 20 is in the vicinity of a location identifying device 50, the smartphone 20 and location identifying device 50 communicate with one another via Bluetooth Low Energy and the location identifying device 50 is able to define the location of the smartphone 20 within a small radius. The location information is then transmitted by the smartphone 20 to the computer server 30 and the system software 40 will then extract from the computer server 30 the information for that location and transmit that location-based information to the smartphone 20.

The system 10 also allows the prospective buyer or his or her real estate agent to communicate through the system 10 with the listing agent. In a first preferred embodiment, the prospective buyer and real estate agent can provide feedback to the listing agent by selecting the feedback option 68 on the software application 15 menu or can communicate with the listing agent regarding the next step in the process by selecting the Next Steps option 70 on the software application 15 menu. It should be appreciated that the system 10 could also include other types of communications and interactions between the listing agent and the prospective buyer and his or her real estate agent within the spirit and scope of the invention.

Use of the system 10 of the present invention will enable listing agents to show properties with full disclosure of the information relevant to the property without being present. In this manner, listing agents will be able to show properties to prospective buyers at the prospective buyer's convenience and to show multiple properties at the same time. This capability will decrease the risk that a prospective buyer will end up buying another property because they were unable to see the listing agent's property due to the listing agent's unavailability. It will also likely increase the listing agent's sales because, logically, being able to show more properties to more prospective buyers will result in more properties being sold.

Of course, it is possible today for the prospective buyer's real estate agent to show the property to the prospective buyer without the listing agent being present. However, the listing agent is typically able to provide the best and most complete description of the property and to make the best sales pitch due to their more extensive understanding of all information relevant to the property that they listed. This virtual real estate agent capability is a significant improvement over the current real estate agent business model and will change the way real estate agents operate and the manner in which properties are shown.

The prospective buyer and/or his or her real estate agent may also elect to receive alerts from the computer server 30 when they pass by available listed properties that have one or more location identifying devices 50. Using this feature, the prospective buyer and/or his or her real estate agent can enter preferences for the characteristics they are seeking, such as number of bedrooms, number of bathrooms, guard gate, swimming pool, asking price range, etc., and when they come within the range of a location identifying device 50 for a property having these desired characteristics, a message can be sent to their smartphone 20 through the system 10 alerting them that they are in the vicinity of a property meeting their desired characteristics. In this manner, they will be able to view properties that they may not have otherwise been informed of and will be able to do so efficiently when they are actually in the vicinity of the property. Also, the ability to define their desired characteristics will result in them only be alerted to properties that satisfy their desired characteristics so that no time is wasted receiving alerts and reviewing information about properties that do not. This feature will benefit home sellers by providing assurance that prospective buyers in the vicinity of their listed property will be alerted of the property at a time when they can at least view the property externally. The prospective buyer can then activate the manual tour 60 to view and receive information about the property virtually and can also communicate through the system 10 to view frequently asked questions about the property 66 or with the listing agent to get further information and make arrangements to tour the inside of the property.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

I Claim:

1. A system for providing information to a user based on the user's location comprising:
a communication device;
at least one location identifying device;
wherein each location identifying device communicates location identification information to the communication device when the communication device is within a certain range of the location identifying device;
a control system having location-based information and means for communicating with the communication device; and
wherein the control system receives location identification information from the communication device and transmits the location-based information to the communication device based on the location identification information received from the communication device.
